(19) United States
(12) Patent Application Publication
(10) Pub. No.: US 2025/0378767 A1
(43) Pub. Date: Dec. 11, 2025

(54) INTRODUCTORY SEXAGESIMAL TEACHING CLOCK

(71) Applicant: CLAUDINE CC ELIAN, SEDRO-WOOLLEY, WA (US)

(72) Inventor: CLAUDINE CC ELIAN, SEDRO-WOOLLEY, WA (US)

(21) Appl. No.: 18/738,713

(22) Filed: Jun. 10, 2024

(51) Int. Cl. G09B 19/12

(52) U.S. Cl. CPC G09B 19/12

(57) ABSTRACT

The present invention relates to introductory teaching timepieces in general and specifically to a novel design applicable to watches and clocks whereby only the second hand is present and from which the minute and hour hands have been removed. The second hand moves in equally timed units such that one full cycle of its motion consists of 60 equally timed seconds. In doing so, it isolates the sexagesimal basis for time-telling so that the beginner can understand this numerical system prior to combining it with the duodecimal system used for minutes and hours.

### FIELD OF THE INVENTION

The present invention relates to an introductory teaching timepiece with only the second hand present and used as a method to teach children the behavior of time as a continuous motion that is organized into sexagesimal units of seconds that then become the foundation for each minute.

### BACKGROUND OF THE INVENTION

That the learning of time is essential for literacy but also difficult for children to learn is recognized by all whose inventions are intended to facilitate this process:

“The difficulty with teaching a child to tell time relates to the concept of motion of the clock's hands . . . . Further the concept of a ‘little’ hand and a ‘big’ hand and the corresponding hours and minutes can be difficult to grasp”; U.S. Pat. No. 5,863,205A, Martens—

“Learning to tell time from an analog clock is one of the most challenging and difficult skills that elementary school children need to learn in their arithmetic classes. The learning process generally covers a three year period of a child's education from kindergarten to second grade before most children can master this skill of telling time from an analog clock.” U.S. Pat. No. 6,071,124, Ang and Tong, 2000

The above observations lead one to ask: “Why is it so difficult, and why does it take so long for a child or beginner to learn to tell time?”

The present invention addresses and remedies 3 likely reasons:
I. Children are expected to simultaneously master a sexagesimal system for the minutes and a duodecimal one for the hours.
II. Prior art does not take advantage of a child's very long learning curve for telling time and therefore does not take the progressive approach of introducing building blocks prior to combining a timepiece's elements of seconds, minutes, and hours.
III. The fundamental behavioral and conceptual aspects of time are not deemed a significant aspect of the learning process. Because of this, the visible demonstration of the ceaseless motion of the earth's rotation that time measures is not associated with a timepiece during the learning process; children are thus expected to learn how to identify and manage a behavior whose source is unfamiliar to them.

### Regarding I):

Children are expected to simultaneously master a sexagesimal system for the minutes and a duodecimal one for the hours.

All prior art focuses upon minutes and hours in tandem as the elements to be learned, and whenever a timepiece features both minute and hour hands, it has inevitably combined the sexagesimal and duodecimal counting systems. This design forces any learner to master two different and unfamiliar counting systems in combination with one another.

As challenging as this must be for a young mind when math literacy is just beginning, the presence of both minute and hour hands is assumed to be mandatory for any learning timepiece. To wit:
U.S. Pat. No. 5,851,118A, Woldenberg and Po: “A teaching clock comprising an analog clock face having numeric indicia of hour and minute disposed about its periphery,”
U.S. Pat. No. 7,136,327B2, Hopkins, “Novel hour and minute hands for teaching reading and passage of time on an analog timepiece”;
U.S. Pat. No. 5,863,205A, Martens; Learning Clock—Learning clock featuring coordinated color clock face numbers, hour and minute hands, and hour and minute hand learning displays;
U.S. Pat. No. 4,885,731A, Massaro: “An analog timepiece face that contains a smaller hour portion (A) concentrically positioned within a larger minute portion (B)”
U.S. Pat. No. 4,219,943, Grimes: “This invention relates generally to time teaching aids and particularly to a clock for teaching time fundamentals to children.”
JP20000132087A, Seibunshiya KK: “This timepiece for learning is constituted by forming a hour hand and minute hand respectively mounted at a shaft . . . .”
JP2808436B2, Yohin: “The minute hand and the hour hand are projected from the peripheral surface of the timepiece body . . . ”
JP2007171147A, Masayhoshi: “This watch surface dial is formed into double circles with the minute hand circle and the hour hand circle colored with different colors.”

The difficulty of this combinatory task of numerical systems is nonetheless recognized and addressed in multiple ways such that minute and hour hands have distinct identities or areas. Among others, it is addressed through: design elements (U.S. Pat. No. 5,030,104), color codes (U.S. Pat. Nos. 4,219,943, and 4,124,945), the inclusion of text (U.S. Pat. No. 6,071,124), and novel hand designs (U.S. Pat. No. 7,136,327).

However, no prior art seeks to teach the fundamentals of time by separating the two counting systems. The present invention does so by focusing exclusively on the second as one of the two sexagesimal units used for measuring time, and upon its role in building up the other sexagesimal unit, the minute.

### Regarding II)

Prior art does not take advantage of a child's very long learning curve for telling time and therefore does not take the progressive approach of introducing building blocks prior to combining a timepiece's elements of seconds, minutes, and hours.

One fact that remains under-leveraged in teaching children how to tell time is that in the early stages of learning, no one actually expects them to be able to do it. The young age at which they begin and well beyond the midpoint of their 2-3 year learning curve requires that there always be a person already able to read a clock to measure time on their behalf.

The beginning of a child's learning journey is then the ideal period for the simplification and isolation of time-telling's elements. It's akin to explaining to a beginner driver how the different parts of a car work together. One cannot say that now they now know how to drive, but they will know why driving requires a coordination between several elements under their control (steering wheel, brakes, acceleration pedal, et al.)

In similar fashion, to teach time in steps by way of extracting and isolating the elements of a timepiece simplifies the learning process. The present invention does it by extracting the movements of the second hand away from those of the minutes and hours. This isolation inevitably brings attention to the sexagesimal nature of what seconds measure and how this is the foundation for the measure of each minute, all the while illustrating the non-stop orbital movement upon which the telling of time is based.

Although children are told that 60 seconds make up a minute of time, the constant flow that seconds measure is overlaid with the counting of minutes and their foundation as the building blocks of hours. As a result, the second hand's behavior and role are virtually unnoticed by them. Children are sensitized instead to specific minutes positioned before or after a specific hour.

A progressive introduction and teaching of time can be done in such a way that at each stage of understanding the learner has an understanding of that stage's foundation for the next level of complexity. The logical teaching progression would thus be: a) how time flows; b) how seconds illustrate this flow; c) how a full revolution of the second hand equals one minute; d) how 60 minutes equal an hour; e) how 24 hours equal a day.

The removal of the need to learn to tell time via minutes and hours also frees the child (or even older learner) to first get into the behavior of time and to understand this behavior enough to appreciate the need for stable and predictable points of time, starting with the minute—something they can see in action via one full revolution of the second hand.

This learning via extracted elements makes it far easier for the child to merge the sexagesimal counting system with the duodecimal one. Once they are familiar with the role of the second hand in building up each minute, they can use this understanding when they are taught that the minutes between the numerals 1 and 2 of a standard timepiece consist of five revolutions of the second hand, thus five minutes.

This then becomes a step for the child to be introduced to the duodecimal system by multiplying the numerals of the hour by 5 to know the total minutes elapsed. Thus the “2” of the clock is not a 2 of minutes, but of how many times 5 minutes are to be multiplied, hence “10” minutes.

From there it is easy to grasp that the full revolution of the hour hand consists of 5×12 minutes, thus a return to the sexagesimal system with which they have already become familiar in the form of the second hand's role.

### Regarding III)

That time has fundamental behavioral and conceptual aspects to it is readily acknowledged in prior art:

“The goal of the proposed design of a timepiece is to provide a good mental model of the clock for the child since there is evidence that people learn to use devices more readily if they have the appropriate conceptual or mental model of how things work.” U.S. Pat. No. 4,885,731A, D. Massaro

“An understanding of the concepts of time is very important to a child's independence and development. U.S. Pat. No. 7,515,509 B2, Klein; 2009

“Thus, there exists a need to provide a teaching watch and method of teaching time which conveys the fundamental principles of the time displayed on the watch.” U.S. Pat. No. 9,082,314, Tsai,

“ . . . provide a timepiece which enables schoolchildren in the lower grades to exactly understand the concept of timepiece.” JP2808436B2, Yohin.

“ . . . . It is often forgotten by teachers that all teaching of a new subject must begin with fundamentals and this is particularly true in the case of teaching children to tell time.” U.S. Pat. No. 4,219,943 1980, Grimes

Even with these motivations, what is being focused upon is the functionality of how to tell time, not the fundamental of time's astronomical foundation as the orbit of the earth around its axis, nor how this motion is represented and stabilized into the concept of time, starting with the brief sexagesimal units that seconds measure.

The fundamental fact of time is not its measurement, but its behavior, for time never stands still nor can it since it is based upon the orbit of the earth, something that places us in a different location at every instant in relation to the sun.

Inventors may well recognize this last fact as the source for their own learning clocks: U.S. Pat. No. 4,885,731, 1989, Massaro: “The main feature of clocks, whether analog or digital, is the measure of time or duration. A timepiece is based upon the principle of equating a spatial distance (the movement of the earth around its axis of rotation) with an interval of time.”

And yet, no prior art seeks to leverage this fact into an essential aspect of the introductory teaching process. The sensitization of the learner to what it is exactly that is being measured, is not a stated goal—how to “tell time” is. Children are thus asked to learn to measure something whose behavioral character they have not been made to observe with any degree of depth.

The concept of time is not the behavior of time but the creation of a system of observable fixed units that are cyclical, predictable, and in tandem with the earth's rotation.

As difficult as it is even for adults to illustrate a concept, the sweep of the second hand and its ungraspable nature is a close enough simulation of time's non-stop behavior to not only give the learner a taste of time's ceaseless flow but it also points to the need for establishing fixed points—something that is possible because time (the earth's rotation) is predictable and cyclical—just as a timepiece can demonstrate.

By demonstrating the movement of time exclusively in terms of seconds, the present invention addresses the “fundamental principles” as well as the “concept” of time.

Unlike the comparatively stationary minute, to display that a second is happening occurs in the observation of its passing. This is why seconds are not focused upon in the traditional method of teaching time. Even if one where to recognize the value of the second hand, to include a third hand in a teaching timepiece would overload an already challenging agenda for the clear majority of learners.

However, the cursory attention given to the second hand is a wasted opportunity, for doing so can both demonstrate the ceaseless motion of time and also act as an interface between this aspect and its fixation into predictable and stable units. This gap in the teaching of the fundamentals of time and the concept of its organization into cyclical units is what the present invention is created to remedy.

### BRIEF SUMMARY OF THE INVENTION

This invention is a modification of the conventional analog clock and is intended to introduce children to both the fundamentals of time and to its representation as fixed units starting with the sexagesimal ones indicated by seconds and from which there is a progression into the other two units, minutes, then hours.

The present device consists of an analog timepiece with only a second hand in rotation about a central axis; there are no minute or hour hands to add to the learning challenges. As a result, it focuses only on the sexagesimal counting system with the goal of teaching what the second represents and how it builds up each minute.

It is intended that any timepiece face can be so modified, be it a clock, wristwatch, pocket watch, and with any shape of casing, be it square or circular, with Arabic, Roman, or implied numerals.

The second hand's movement can be continuous or staccato.

With this modification, all 3 limitations of prior art described in the “Background of the invention” are removed.

I) Children are expected to simultaneously master a sexagesimal system for the minutes and a duodecimal one for the hours.

With the present learning timepiece, the goal is to teach only the behavior of the second, the first of the two sexagesimal units of time, and its basis for the second sexagesimal unit, the minute. This speeds up the learning process by focusing on the fact that 60 seconds create a minute, which then makes it far easier for the child to understand how 60 minutes create one hour.

Since this is an introductory timepiece that focuses upon the sexagesimal system for measuring seconds, the duodecimal counting system can eventually be presented by way of a conventional analog timepiece, but only when the child is sufficiently familiar with the sexagesimal one.

II) Prior art does not take advantage of the very long learning curve for telling time.

By removing the minute and hour hands and leaving only the second hand in motion, the current invention's modification of the traditional timepiece differs from other analog learning timepieces because it seeks to teach the nature and unitization of time in progressive steps, and not all at once. By eliminating the need to simultaneously understand minutes and hours, the student can build a solid foundation for combining the sexagesimal and duodecimal systems at a later point.

This progressive introduction and teaching of time can be done in such a way that at each stage of understanding the learner is sufficiently primed for the next level of complexity. As stated earlier, the learning progression would thus be: a) how time flows; b) how seconds illustrate this flow; c) how a full revolution of the second hand equals one minute; d) how 60 minutes equal an hour; e) how 24 hours equal a day.

III) The fundamental and conceptual aspects of time are not a significant goal of the learning process. Because of this, the visible demonstration of the ceaseless motion of the earth's rotation that time measures is not highlighted during the learning period; children are thus expected to learn how to identify and manage a behavior with which they are unfamiliar.

As such, a timepiece with only a second hand is the ideal object with which to both introduce the student to the fundamental nature of time and to its fixation. By limiting its activity to the length of a second, 60 of which constitute a minute, the present invention can be used as a teaching adjunct in bi-directional fashion. First to indicate time's source event, namely the daily rotation of the earth, which is illustrated in the isolated second hand's sweep around its axis. And secondly, to establish that basing the length of each minute on one revolution of the second hand, 60 seconds, fixes the endless flow of time into predictable, cyclical, and utilitarian units.

The absence of the minute and hour hands is essential to this invention and is intended to demonstrate how time behaves. By observing a virtually ungraspable unit, the second—a unit that is already outdated by the time it has been indicated—the student is sensitized to both the non-stop nature of time, and intuitively understands the necessity for units longer than a second to fix points in time.

It also introduces and reiterates the fundamentals of time by illustrating the origin of any measurement of time, namely the constant rotation of the earth about its axis, as evidenced by the sun's cyclical and non-stop journey in the sky. This organic movement provides us with the information of how recently night ended and how soon it will arrive—something that a timepiece does with added precision.

The cyclical nature of the second hand's rotation around a fixed axis and its passage along regularly fixed points, connects this invention to both the source of the event that timepieces represent, and to the next stage in the student's learning of time as the specific durations of the minute and hour hands in constant and regular rotation around a central axis.

It is important to emphasize that this invention is an introductory timepiece and made to be a springboard to conventional analog teaching clocks; it is not intended to replace them.

Its purpose is to offer a preliminary experience of time by pointing to the past (the astronomic basis for time) and to the future (the human creation of a device that stabilizes time). This expectation of additional and external instruction is consistent with prior art since all learning clocks are intended to be used under the direction of a guide, be it a parent or a teacher.

### DETAILED DESCRIPTION

The present invention relates to analog teaching timepieces in general and specifically to a novel design whereby only sexagesimal foundation of time is represented by way of the second hand's movements to indicate 60 units each of 1 second's duration. It. Is intended to be used as an introductory adjunct for the teaching and illustration of time's behavior as a ceaseless flow and its subsequent organization into cyclical and predictable minutes based upon 60 seconds to each one, and from which 60 minutes become an hour.

This invention is therefore intended to be an introductory sexagesimal teaching timepiece consisting of an analog clock face with either numeric or abstracted indicia of at least sixty seconds of time peripherally located in equal units around its circumference, and with only a second-hand pivotally mounted and centrally placed in relation to the analog clock face. There are no minute or hour hands.

This invention's format can be applied to any analog timepiece regardless of size, be it a wristwatch or a wall clock, and is not limited to any particular model as long as the general indica of a timepiece are present: a symmetrically enclosed area, be it circular, rectangular, triangular, and in the center of which a single second-hand rotates clockwise about an axis at a steady rate of 60 parts per minute and with the enclosed area containing indica for the units of 60 seconds equally spaced around the periphery of the face, also with numerals at its periphery, either explicit as in FIGS. 1-2, 4-5, or implicit as in FIGS. 3 and 6, in either the Arabic (FIG. 1, and FIG. 2) or Roman style (FIG. 4 and FIG. 5).

The above descriptions do not exhaust all the modifications that are possible and which would remain true to the scope of this invention.

Because it is an introductory sexagesimal teaching timepiece, this invention primes the student to transfer their knowledge of 60 seconds as the basis for each minute to any subsequent timepiece used for the learning of 60 minutes as the foundation of each hour, and so on to the 24 hours of the day.

It is up to the instructor to create a bridge for the learner both to the astronomical basis for time's ceaseless motion as illustrated by the second-hand, and to any timepiece as the representation and that motion into increasingly long predictable units: seconds to minute; minutes to hours; hours to days.

The circular rotation about a fixed center point recreates the cyclical nature of the earth's rotation about its axis, whose own movement is what hours and minutes are intended to measure. Absent a watch or clock, we would all need to look to the sky to determine how early or late in the day it is. The seemingly continuous motion of the second hand reiterates this ceaseless rotation of the earth about the sun.

This parallel behavior is something that the teacher can indicate to the learner simply by pointing to the constantly shifting positions of the sun and the ongoing flow of the second hand sweep about the circumference of the timepiece.

In this manner, this invention focuses upon the sexagesimal counting system and isolates it from the duodecimal system used for hours so as to facilitate the learning curve. Otherwise, a child is faced with simultaneously learning the sexagesimal and the duodecimal system at a time when they are still learning basic math fundamentals.

Even though it consists of the removal of known components, the inventor believes that this invention meets the standard of novelty and is, in every way, true to the spirit of invention that has been upheld by the U.S. Court of Appeals and by the Supreme Court of the United States:

“It is idle to say that combinations of old elements cannot be inventions; substantially every invention is for such a ‘combination’: that is to say, it consists of former elements in a new assemblage.” (Hand., J.) (cited with approval in KSR Int'l Co. v Teleflext, Inc., 550 U.S. 398 (2007). See e.g., Reiner v. I. Leon Co., 285 F2d 501 (2d Cir. 1960)

### BRIEF DESCRIPTION OF THE DRAWINGS

All the figures show a sample face of a timepiece with the second hand present and the hour and minute removed. These are nonetheless indicated with dashed lines to make it clear that a single hand is not intended to represent anything but the unit of a second and not minutes or hours—as is the case in U.S. Pat. No. 5,134,596, ANALOG TIMEPIECE WITH SINGLE HAND FOR DESIGNATING HOURS AND MINUTES.

a.

FIG. 1—Representational circular timepiece face with second hand only, Arabic numerals, and indica of 60 seconds presented as equally spaced dots around the external periphery of the numerals. Absence of minute and hour hands indicated by dashed lines.

FIG. 2—Representational circular timepiece face with second hand only, Arabic numerals, and indica of 60 seconds presented as equally spaced lines inside the periphery of Arabic numerals. Absence of minute and hour hands indicated by dashed lines.

FIG. 3—Representational circular timepiece face with second hand and implied hourly numerals and indica of 60 seconds presented as equally spaced shorts lines around the external periphery. Absence of minute and hour hands indicated by dashed lines.

FIG. 4—Representational circular timepiece face with second hand only, Roman numerals, and indica of 60 seconds presented as equally spaced lines around the external periphery of the numerals. Absence of minute and hour hands indicated by dashed lines.

FIG. 5—Representational square timepiece face with second hand only, Roman numerals, and indica of 60 seconds presented as lines proportionally located around the external periphery of the numerals.

FIG. 6—Representational rectangular timepiece face with second hand and implied numerals and indica of 60 seconds presented as proportionally spaced shorts lines around the external periphery. Absence of minute and hour hands indicated by dashed lines.

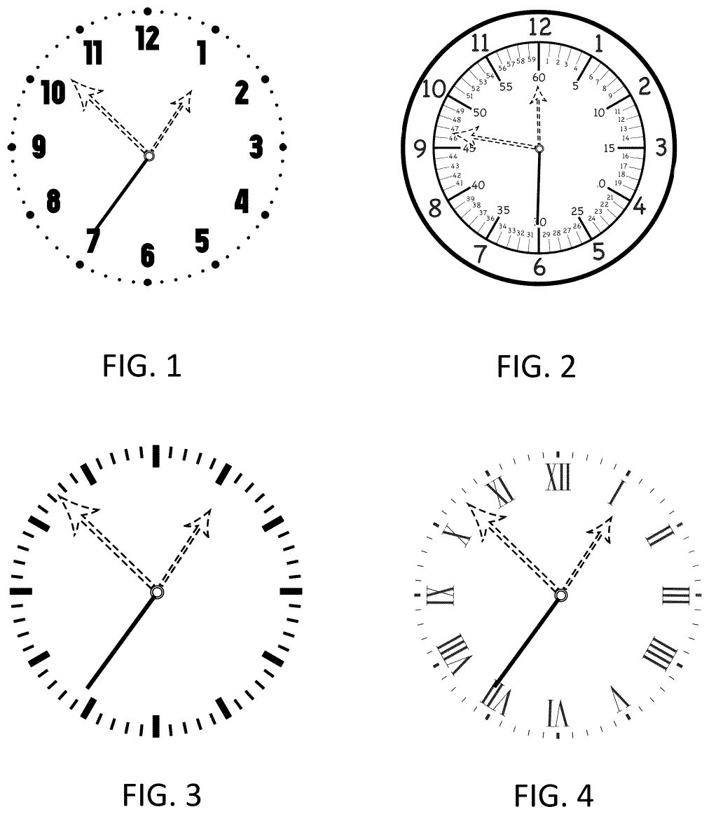

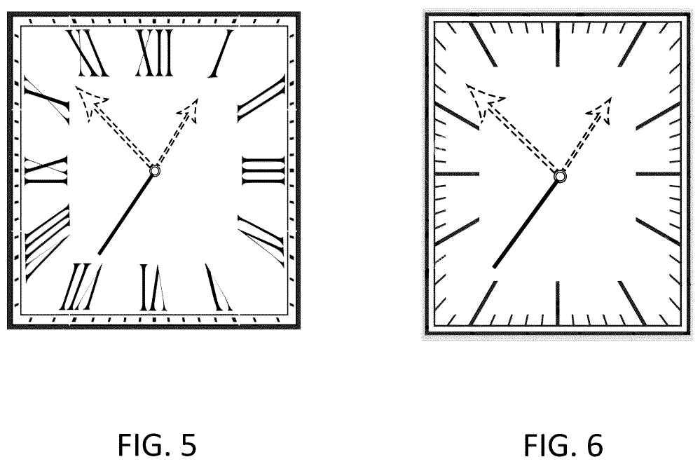

What is claimed:

1. An analog time telling device comprised of a second hand in motion over a timepiece face such that one full cycle of the second hand's movements depicts 60 seconds, with equally timed indica to represent each of the 60 seconds, and without the presence of either a minute or an hour hand.

2. The device of claim 1 wherein there are numerical indica for the hours.

3. The device of claim 1 wherein analog time is recreated in digital form.
